(19) United States
(12) Patent Application Publication
(10) Pub. No.: US 2003/0113490 A1
(43) Pub. Date: Jun. 19, 2003

(54) Polyester bottles with reduced bottle-to-bottle friction

(76) Inventor: Zo-Chun Jen, Taipei (TW)

Correspondence Address: WILLIAM J. MASON, MACCORD MASON PLLC, POST OFFICE BOX 1489, WRIGHTSVILLE BEACH, NC, 28480, US

(21) Appl. No.: 10/017,420

(22) Filed: Dec. 13, 2001

(51) Int. Cl. B32B 1/02

(52) U.S. Cl. 428/35.7

(57) ABSTRACT

Polyester bottles having reduced bottle-to-bottle friction and an absence of visible haze are manufactured from a polyester polymer containing an effective amount of uniformly dispersed barium sulfate as a friction-reducing additive. Preferably, the barium sulfate is present in the polyester composition in the range of from about 0.001 wt. % to about 0.1 wt. %, and has an average particle size of from 0.1 micron to 2.0 microns. The polymer may be first formed into a preform that is subsequently blown into the desired bottle configuration.

### BACKGROUND OF THE INVENTION

(1) Field of the Invention

The present invention relates generally to the manufacture of polyester bottles, and in particular to polyester bottles exhibiting reduced bottle-to-bottle friction during conveying and palletizing, while having an absence of visibly discernable haze.

(2) Description of the Prior Art

Polyester, especially polyethylene terephthalate, is highly useful in the preparation of a variety of molded products. The polymer is particularly suited to the preparation of bottles, such as beverage containers, since the resultant bottles have excellent strength and clarity.

Polyester bottles are normally produced by first molding a bottle preform, which is later expanded within the cavity of a mold to the final bottle shape. After the bottles are manufactured, they are conveyed from the blow molding devices to a palletizer, where a large number of the bottles are stacked onto a pallet for shipment to the bottler. During conveying and palletizing, the bottles come into surface contact with each other. With conventional polyester formulations, the bottles tend to exhibit a high level of bottle-to-bottle friction, i.e., surface adherence or stickiness, which can interfere with conveying and palletizing of the bottles, reducing the overall efficiency of the operation.

U.S. Pat. No. 5,830,544 to Kerscher et al. attempts to address this problem by incorporating amorphous silica into the polyester formulation. However, only very small quantities, i.e., 0.0025 to 0.0050 wt. %, of amorphous silica are permissible. Greater percentages of amorphous silica tend to cause haziness in the finally blown bottle, which is unacceptable in the packaging of beverages, as well as for many other applications.

Thus, there is a continuing need for a method of reducing bottle-to-bottle friction between polyester bottles during conveying and palletizing, as well as for resultant bottles that exhibit reduced bottle-to-bottle friction without visual haze.

### SUMMARY OF THE INVENTION

The present invention is directed to improved polyester bottles exhibiting reduced bottle-to-bottle friction and the absence of visual haze, and to preforms used to make such polyester bottles. The invention further relates to an improved method of making polyester bottles that exhibit reduced bottle-to-bottle friction.

Various inorganic and organic additives have been used in the prior art to increase the “slipperiness” of polyester film. Prior art inorganic additives include barium sulfate, silica oxide, calcium carbonate, calcium phosphate, talc, zeolite, titanium oxide, aluminum oxide, calcium fluoride, lithium fluoride, kaolin, and iron oxide. Organic additives used to increase “slipperiness” include divinylbenzene polymer, styrene-divinylbenzene copolymer, crosslinked acrylic resin, various types of ion exchange resins, and organic pigments such as anthraquinone.

These additives are all generally useful in imparting a moderate roughness to the film surface, thereby reducing friction between abutting film surfaces. However, such materials have heretofore only been used in reducing the friction of films, such as magnetic video and audio recording tapes, and capacitor films. Representative disclosures of such usage can be found in U.S. Pat. No. 5,833,905 to Miki, and U.S. Pat. No. 6,048,626 to Tsuzuki et al.

Such additives have not heretofore been used in the manufacture of polyester beverage containers or their preforms, however, due to the need to maintain a high degree of clarity, i.e., absence of haziness, in such bottles. Surprisingly, it has been found that one of these additives, barium sulfate, can be used to reduce the surface friction of polyester bottles without adversely affecting the bottle clarity, if the barium sulfate has an average particle size within the range disclosed herein, and if the barium sulfate is used in the amounts described.

Generally, it has been found that bottle-to-bottle friction of polyester containers can be significantly reduced without causing visually discernable haze by incorporating effective amounts of barium sulfate (BaSO₄) as a friction-reducing additive into the polyester composition. More specifically, the barium sulfate added to the composition is effective in reducing bottle-to-bottle friction to an acceptable level while still maintaining the desired clarity, if the barium sulfate is present in the polyester composition in the range of from about 0.001 wt. % (10 ppm) to about 0.1 wt. % (1000 ppm), and preferably from about 0.005 wt. % (50 ppm) to about 0.05 wt. % (500 ppm). In order to achieve the desired results of the invention, the barium sulfate should have an average particle size of from 0.1 micron to 2.0 microns, and preferably from about 0.2 micron to about 1.0 micron.

### BRIEF DESCRIPTION OF THE DRAWINGS

FIG. 1 is a side view of polyester bottle preform.

FIG. 2 is side view of a polyester bottle.

### DETAILED DESCRIPTION OF THE INVENTION

The present invention is generally useful with the various polyester polymers normally used on the manufacture of clear bottles, such as beverage containers. Polyester compositions are generally prepared by the esterification of a diacid and a diol, and may also be prepared by the transesterification of a diester, such as dimethyl terephthalate, and a diol, followed by polycondensation. Transesterification catalysts such as the acetates of zinc, manganese, cobalt, sodium and calcium can be employed individually or in combination, while polycondensation catalysts include antimony compounds (such as antimony acetate, antimony oxides), germanium compounds, and titanium compounds. The commonly used diacid is terephthalic acid, while the normal diol is ethylene glycol. Copolyesters can be formed with the two or more diacids or diols. Representive examples of substitute diacid components are isophthalic acid, adipic acid, 2,6-naphthalene dicarboxylic acid, etc. A substitute diester is dimethyl 2,6-naphthalene dicarboxylate. Representative examples of substitute diol components are diethylene glycol, 1,4-butanediol, cyclohexanedimethanol, 1,3-propandiol, etc. The specific reaction conditions for polyester production are well known in the art and are not per se a part of the present invention.

These polyester compositions used for bottles are normally produced by melt phase polymerization, followed by solid-state polymerization Generally speaking, after the melt phase polymerization the intrinsic viscosity (I.V.) reaches a level of about 0.5 to 0.7. Higher I.V. levels are not practically achievable by melt phase polymerization without degradation of the polymer. In order to raise the I.V. to the level normally used for bottles, the melt phase product is first pelletized and the temperature is lowered to room temperature. The pellets are then further polymerized by solid-state polymerization by heating with a nitrogen blanket at about 200° C. to increase the I.V. to 0.7 to 1.1, preferably 0.72 to 0.88.

Polyester beverage containers and other clear polyester bottles are conventionally formed by first injection molding a preform, followed by stretch blow molding of the preform to the desired bottle configuration. If the bottle is for a hot fill application, a heat setting will be applied to the bottle during the stretch blow molding process. Alternatively, with some polyester formulations having sufficient integrity, the polyester may be extrusion blow molded without the intermediate preform stage.

The polyester compositions used to prepare the preforms and bottles of the present invention are preferably prepared by incorporating the BaSO₄ during the melt phase. A slurry may be formed of BaSO₄ and ethylene glycol, and milled to ensure a uniform dispersion of BaSO₄/ethylene glycol without any agglomeration. Preferably, the BaSO₄ should not exceed 75% by wt. of the slurry. This slurry is added into the melt phase polymerization process, preferably at the esterification stage. An amount of slurry sufficient to achieve the desired percentage of BaSO₄ is used. Alternatively, the BaSO₄ can be added into the TA/EG slurry, added directly to the polymer melt at the end of the polycondensation process, added into the extruder during the injection molding of the preform, or made into a master batch of BaSO₄ and PET via a compounding process, and then adding the master batch to the extruder.

Bottle haziness is attributable to a variety of factors known to one skilled in the art. Major factors include the rates of cooling and crystallization, and the thickness of the bottle wall. When additives such as the BaSO₄ of the present invention are incorporated in the polymer, the particle size and wt. percent of the additive will affect the rate of crystallization, and thereby the likelihood of haziness. It is within the ability of one skilled in the art to select the effective amount of BaSO₄, based on the appropriate quantity and particle size combinations suitable for a particular wall thickness and the conditions under which the bottle, and any preform, are produced.

In selecting the appropriate size and quantity of BaSO₄, an average particle size of less than about 0.1 micron should be avoided, since it has been found that particle sizes below 0.1 micron have a significant nucleation effect in the polyester, resulting in an increased PET crystallization rate, and likelihood of haze. Generally, a higher percentage of BaSO₄ can be used in polyester compositions formed into bottles with a thinner wall and/or when the BaSO₄ particles are of a larger size. Conversely, a smaller percentage of BaSO₄ will normally be used with thicker bottle walls and/or smaller size BaSO₄ particles. The criteria for all compositions are to produce bottles that exhibit reduced bottle-to-bottle friction, while being characterized by an absence of visible haze or cloudiness.

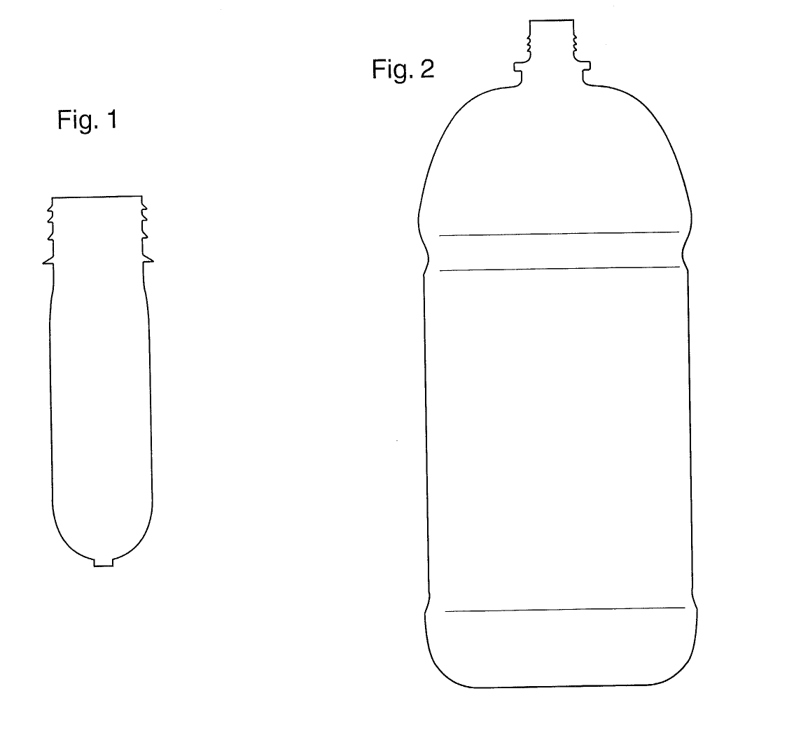

In the preferred embodiment, the polyester/ BaSO₄ compositions are first formed into hollow preforms by injection molding. The preform, illustrated in FIG. 1, is generally in the form of a closed end cylinder that has a volume equal to about 1/15th to about 1/30th of the volume of the final bottle. The preforms, after cooling, are normally conveyed or shipped to another location, where they are heated to 80-140° C., normally by Infrared Lamps, and biaxially stretched, e.g., by blow molding, to the shape of the final bottle.

The BaSO₄-containing polymers can be used to manufacture a variety of bottle shapes, and the actual bottle shape is not a critical feature of the invention. However, the problem with bottle-to-bottle friction is more commonly experienced with bottles with straight vertical sides, since there is a larger bottle-to-bottle contact surface. An example of a bottle of this type is the common 2-liter soft drink bottle, such as illustrated in FIG. 2. Bottles of the type contemplated by the present invention normally have a wall thickness of from about 0.12 to about 0.65 mm, and preferably from about 0.2 to about 0.45 mm.

Various additives commonly used in clear polyester bottles can also be used in the polyester compositions, so long as haziness does not result. Such optional additives include thermal stabilizers, light stabilizers, dyes, pigments, plasticizers, antioxidants, lubricants, effusion aids, residual monomer scavengers, and the like.

### EXAMPLES

The friction of bottles prepared from polyester compositions with and without addition of BaSO₄ was compared to illustrate the effectiveness of BaSO₄ in reducing bottle-to-bottle friction. Samples A and B were formed from identical polyethylene terephthalate polymer compositions, except that the composition of Sample B contained 100 ppm (0.01 wt. %) BaSO₄ having an average particle size of 0.5 microns.

Preforms were initially produced for the two samples on a 75-ton Arburg injection-molding machine equipped with unit cavity preform molds. Preforms were 46 gram, two-liter preforms. The preforms were then blown into generic two-liter bottles on a Cincinnati Milacron RHB-L unit cavity blow-molding machine.

Static coefficient of friction testing of the samples was carried out following ASTM method D 1894-90 as closely as possible in order to measure the initial force needed to break the frictional engagement between two surfaces. Kinetic coefficient of friction comparisons were not possible, due to the tendency of the pieces to skip instead of dragging smoothly. In measuring the static coefficient of friction, the points at which the initial friction was broken (Initial Break) were compared. A comparison was also made of the largest force required to break the friction during the 2-inch distance dragging of the sled over the stationary stage (Maximum Break).

In the tests, pieces were cut from bottles prepared from each sample composition. For each test, a 5 inch long piece was attached to the test stage, which is stationary in the course of the test, and a 2.5 inch long piece was attached to the test sled, so that the outer surfaces of the pieces contacted each other during testing. The initial force required to break the contact between the two pieces was then measured, as listed under the column of “Load at Initial Break”. The maximum force to break the contact during the entire 2-inch sliding distance was also measured, as listed under the column of “Load at Maximum Break”. Ten tests were conducted for each sample. The test results are shown in the following tables:

| | | | |
|---|---|---|---|
| Load at | Displacement | | |
| Maximum | at | Load at | Displacement at |
| Break | Max. Break | Initial Break | Initial Break |
| (lbf) | (in) | (lbf) | (in) |

Sample A

| | | | | |
|---|---|---|---|---|
| 1 | 0.386 | 0.322 | 0.307 | 0.137 |
| 2 | 2.741 | 1.375 | 1.382 | 0.197 |
| 3 | 5.374 | 0.395 | 1.733 | 0.076 |
| 4 | 6.158 | 0.226 | 6.099 | 0.222 |
| 5 | 3.050 | 0.397 | 2.259 | 0.147 |
| 6 | 6.134 | 0.225 | 6.064 | 0.223 |
| 7 | 2.417 | 1.478 | 1.428 | 0.066 |
| 8 | 3.325 | 1.926 | 1.536 | 0.082 |
| 9 | 3.321 | 1.464 | 2.475 | 0.112 |
| 10 | 3.839 | 0.360 | 3.191 | 0.127 |
| Mean | 3.674 | 0.817 | 2.647 | 0.139 |
| S.D. | 1.796 | 0.659 | 1.964 | 0.058 |

Sample B

| | | | | |
|---|---|---|---|---|
| 1 | 2.055 | 1.725 | 0.221 | 0.022 |
| 2 | 2.067 | 0.091 | 2.067 | 0.091 |
| 3 | 1.252 | 0.651 | 0.590 | 0.056 |
| 4 | 1.956 | 1.091 | 1.505 | 0.167 |
| 5 | 1.541 | 0.525 | 0.369 | 0.041 |
| 6 | 1.984 | 0.657 | 0.496 | 0.117 |
| 7 | 2.067 | 0.113 | 2.067 | 0.113 |
| 8 | 1.173 | 0.593 | 0.900 | 0.093 |
| 9 | 0.794 | 0.952 | 0.549 | 0.122 |
| 10 | 1.515 | 1.263 | 0.724 | 0.096 |
| Mean | 1.640 | 0.766 | 0.949 | 0.092 |
| S.D. | 0.455 | 0.506 | 0.685 | 0.043 |

Based on the test results obtained, it is shown that there is a greater than 60% reduction in bottle-to-bottle friction with the addition of the BaSO₄. This reduction in bottle-to-bottle friction was achieved without any visually discernable bottle haziness.

Additional polyester samples were prepared containing BaSO₄ in quantities of 0.05 wt. % and 0.10 wt. %, and with particles sizes of 0.1 micron and 0.5 micron. The rate of crystallization of each sample was measured by differential scanning colorimetry. The samples were first heated to 300° C. to ensure that the samples were fully melted, and then cooled at the rate of 20° C./min. The temperature at the peak of the crystallization curve (Tcc) and the enthalpy or heat release (Hcc) measured in joules/gram were measured. As shown by the results, an increase in the quantity of BaSO₄ or a decrease in the particle size, results in an increase in polymer crystallization rate, indicated by a corresponding increases in Tcc and Hcc.

| | | Size | Tcc | Hcc |
|---|---|---|---|---|
| Sample | Wt. % | (m) | ° C. | joules/gram |
| 3 | 0.05 | 0.5 | 197.5 | 46.7 |
| 4 | 0.05 | 0.1 | 201.9 | 49.8 |
| 5 | 0.10 | 0.5 | 198.8 | 46.9 |
| 6 | 0.10 | 0.1 | 200.9 | 50.0 |

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A polyester bottle preform comprised of a polyester polymer containing an effective amount of barium sulfate as a friction-reducing additive.

2. The bottle preform of claim 1, wherein said polyester polymer is selected from polyethylene terephthalate and modified polyethylene terephthalate.

3. The bottle preform of claim 1, wherein said polymer contains up to about 0.1 wt. % barium sulfate having an average particle size of from about 0.1 to about 2.0 microns.

4. The bottle preform of claim 1, wherein said polymer contains from about 0.005 to about 0.05 wt. % barium sulfate.

5. The bottle preform of claim 1, wherein said barium sulfate has an average particle size of from about 0.2 to about 1.0 micron.

6. The bottle preform of claim 1, sized for the manufacture of a two-liter bottle.

7. A polyester bottle exhibiting reduced bottle-to-bottle friction comprised of a polyester polymer containing an effective amount of barium sulfate as a friction reducing additive, said bottle being characterized by an absence of visible haze.

8. The bottle of claim 7, wherein said polyester polymer is selected from polyethylene terephthalate and modified polyethylene terephthalate.

9. The bottle of claim 7, wherein said polymer contains up to about 0.1 wt. % barium sulfate having an average particle size of from about 0.1 to about 2.0 microns.

10. The bottle of claim 7, wherein said polymer contains from about 0.005 to about 0.05 wt. % barium sulfate.

11. The bottle of claim 7, wherein said barium sulfate has an average particle size of from about 0.2 to about 1.0 micron.

12. The bottle of claim 7, wherein said polymer contains about 0.01 wt. % barium sulfate having an average particle size of from about 0.5 microns.

13. The bottle of claim 7, wherein said bottle is a two-liter beverage container.

14. A method for making polyester bottles exhibiting reduced bottle-to-bottle friction and an absence of visible haze comprising:
a) forming a polyester polymer containing an effective amount of barium sulfate as a friction reducing additive; and
b) forming a bottle from said polymer.

15. The method of claim 14, wherein said polyester polymer is selected from polyethylene terephthalate and modified polyethylene terephthalate.

16. The method of claim 14, wherein said polymer contains up to about 0.1 wt. % barium sulfate having an average particle size of from about 0.1 to about 2.0 microns.

17. The method of claim 14, wherein said polymer contains from about 0.005 to about 0.05 wt. % barium sulfate.

18. The method of claim 14, wherein said barium sulfate has an average particle size of from about 0.2 to about 1.0 micron.

19. The method of claim 14, further including the step of forming a preform from said polymer, said bottle being formed by stretch blow molding of said preform.

20. The method of claim 14, wherein said bottle is a two-liter beverage container.
